(19) United States
(12) Patent Application Publication
(10) Pub. No.: US 2007/0151059 A1
(43) Pub. Date: Jul. 5, 2007

(54) Mop head to mop handle connecting system and method

(75) Inventors: Robert E. Petner, Burlington, NJ (US); Charles E. Gengler, Orange, NJ (US)

Correspondence Address: Hollstein Keating Cattell;Johnson & Goldstein P.C., Willow Ridge Exeuctive Office Park, 750 Route 73 South, Suite 301, Marlton, NJ, 08053, US

(73) Assignee: NiceLife, Inc.

(21) Appl. No.: 11/327,696

(22) Filed: Jan. 5, 2006

(51) Int. Cl. A47L 13/20; B25G 3/00

(52) U.S. Cl. 15/145; 16/422

(57) ABSTRACT

A mop connection system employs a mop head support member permanently attached at one end to the cleaning elements of a mop head. Dual arm members extend from the other end of the support member. The arm members are configured to be inserted into dual channels at the lower end of the mop handle. A collar, circumscribing and rotatable around the handle, is positioned over the channel inserted arm members, such that tabs located near the ends of the arm members enter the vertical legs of L-shaped slotted openings cut-out from the collar. The collar is then rotated, which positions the tabs within the horizontal legs of the slotted openings, thus securely connecting the mop head support member and hence the entire mop head in place on the handle. The mop head is removed from the handle by simply rotating the collar in the opposite direction and then withdrawing the mop head from the handle.

### BACKGROUND OF THE INVENTION

The various mops, especially swab mops, routinely used for mopping and cleaning floor surfaces, most commonly comprise a handle section to be held by the user and a mop head which constitutes the cleaning section of the mop. There are many types of mop head connection means which serve to join these two sections. There are also numerous connection systems which permit detachment of a mop head from its handle when it is worn out or needs to be washed during its useful life. Such systems employ threaded connections or removable rivets, bolts, screws, and the like, all of which must be disassembled and separated from the mop and then reinstalled between the handle and the replacement mop. This is not only a time consuming process, but removal of soiled mop heads from such prior art mops usually requires handling the dirty, wet, and unsanitary strands or elements of the mop head. In addition, many prior mop head to handle connectors are difficult to properly assemble and cumbersome to install. Such prior connections are also subject to excessive wear and tear from their repeated removal and reinstallation.

### SUMMARY OF THE INVENTION

It is thus an object of the present invention to overcome the limitations and disadvantages of prior mop head connection systems.

It is an object of the present invention to provide a mop head connection system which comprises an easy, efficient and effective connection and disconnection system between a mop handle and a mop head.

It is a further object of the present invention to provide a mop head connection system which provides for a quick means to remove soiled or worn-out mop heads from their mop handles and to quickly and expeditiously replace fresh mop heads on the handles.

It is another object of the present invention to provide a mop head connection system which is sturdy, to allow multiple connections and disconnections of mop heads from and onto handles.

It is still another object of the present invention to provide a mop head connection system which quickly and cleanly permits replacement of soiled or worn-out mop heads, without the user having to touch the cleaning elements of the mop head.

It is a further object of the present invention to provide a mop head connection system which is simple and economical to produce and which requires a limited number of components.

These and other objects are accomplished by the subject invention, a mop head connection system comprising a mop head support member permanently attached at one end to the cleaning elements of a mop head. Dual arm members extend from the other end of the support member. The arm members are configured to be inserted into dual channels at the lower end of the mop handle. A collar, circumscribing and rotatable around the handle, is positioned over the channel inserted arm members, such that tabs located near the ends of the arm members enter the vertical legs of L-shaped slotted openings cut-out from the collar. The collar is then rotated, which positions the tabs within the horizontal legs of the slotted openings, thus securely connecting the mop head support member and hence the entire mop head in place on the handle. The mop head is removed from the handle by simply rotating the collar in the opposite direction and then withdrawing the mop head from the handle.

The novel features which are considered as characteristic of the invention are set forth in particular in the appended claims. The invention itself, however, both as to its design, construction, and use, together with additional features and advantages thereof, are best understood upon review of the following detailed description with reference to the accompanying drawings.

### BRIEF DESCRIPTION OF THE DRAWINGS

FIG. 1 is an elevation view of a mop employing the present invention.

FIG. 2 is an isometric view of the manner of connection of the mop head support member and the collar of the present invention.

FIG. 3 is an elevation view showing the initial manner of alignment for attachment between the mop handle and mop head.

FIG. 4 is an elevation view of the opposite side to that which is shown in FIG. 3.

FIG. 5 is an elevation view showing components of the present invention, specifically the positioning of the mop head support member into the channel of the handle and the movement of the collar over the support member.

FIG. 6 is an elevation view of the final connection position, once the collar of the present invention is rotated into place.

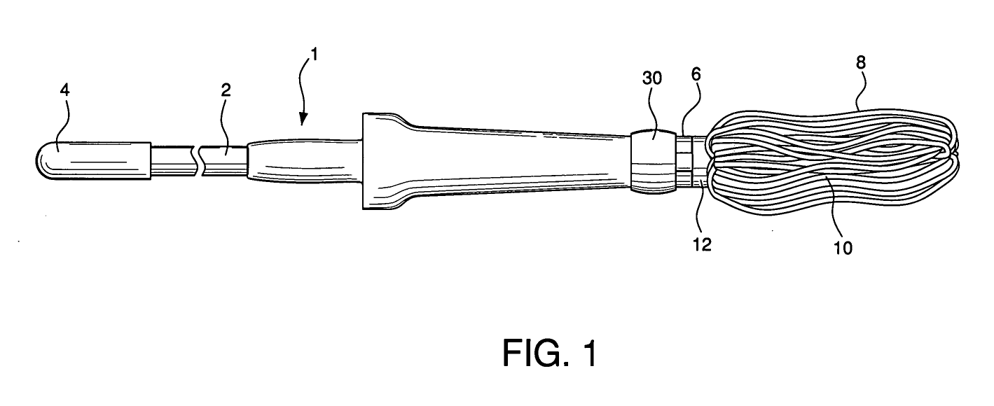

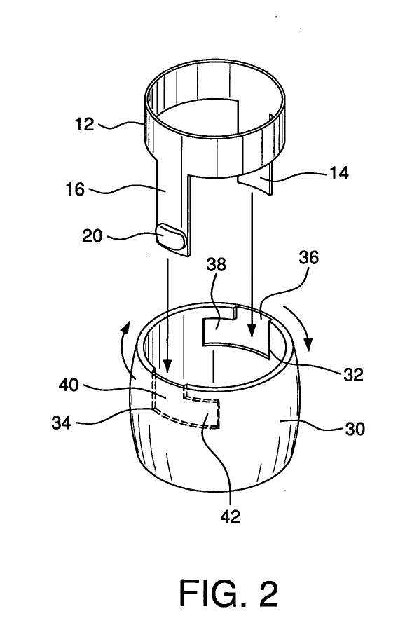

### DETAILED DESCRIPTION OF THE INVENTION

Mop 1 comprises handle 2 with upper end 4 and lower end 6. Mop head 8 comprises cleaning elements in the form of cleaning strands 10. Immovably attached to the top region of mop head 8 is mop head support member 12 comprising support base 13 and outwardly extending arm members 14 and 16. Tabs 18 and 20 extend laterally outward from the lower regions of arms 14 and 16 respectively. Channels 24 and 26 are located within lower end 6 of handle 2 and are configured to receive, for insertion, arm members 14 and 16 of mop head support member 12.

Collar 30 circumscribes handle 2 and is configured to be rotatable around the handle. Collar 30 comprises L-shaped slotted openings 32 and 34, each with perpendicularly aligned leg sections 36 and 38 and 40 and 42 respectively. Slotted openings 32 and 34 are configured to accept, for insertion, tabs 18 and 20 of support member 12

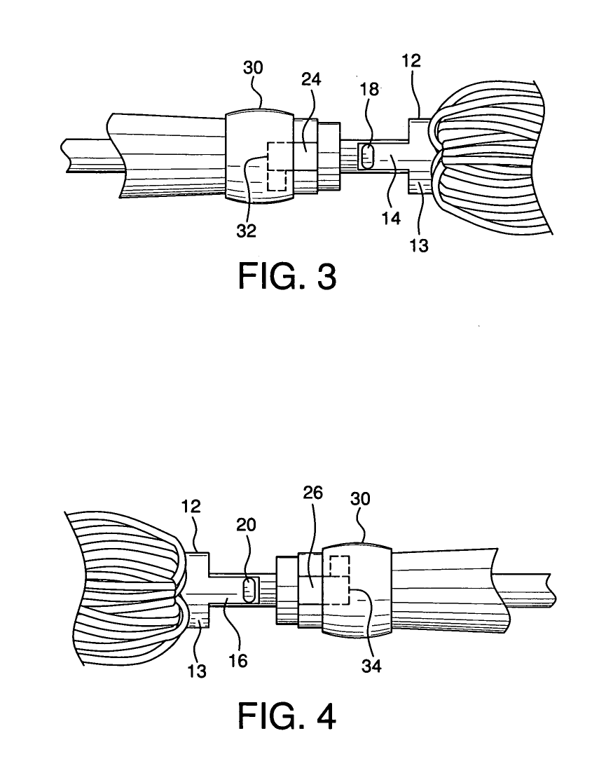

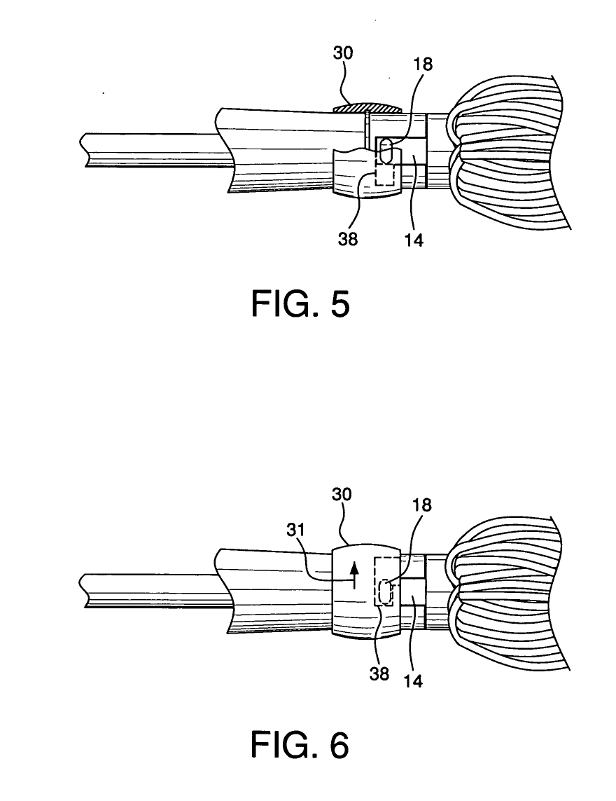

When a mop head, such as mop head 8, is to be connected to a handle, such as handle 2, arm members 14 and 16 are first aligned with dual channels 24 and 26 on the handle. Arm members 14 and 16 are then inserted into channels 24 and 26. See FIGS. 3 and 4. Collar 30 is next positioned over arm members 14 and 16 such that tabs 18 and 20 are located within leg section 36 of slotted opening 32 and leg section 40 of slotted opening 34. See FIG. 5. Collar 30 is then rotated, as shown by directional arrow 31 in FIG. 6. This rotation causes tab 18 to enter leg section 38 of slotted opening 32 (shown in FIG. 6) and tab 20 to enter leg section 42 of slotted opening 34, thereby locking collar 30 in place over arm members 14 and 16 and securely connecting mop head 8 to handle 2.

Mop head 8 is easily removed from handle 2 by simply rotating collar 30 in the direction opposite to 31 and then withdrawing the mop head from the handle.

The system of the present invention can be employed with a handle of any diameter and is not deemed to be restricted to handles which may have larger diameters at their lower ends, as is disclosed in the subject application.

In addition, certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A system for connecting a mop head to a mop handle, said system comprising:
a mop head support member attached to the mop head and comprising outwardly extending arm members;
channel means within the mop handle for receiving the arm members; and
collar means rotatable around the mop handle for securing the arm members to the mop handle, whereby upon insertion of the arm members into the channel means and rotation of the collar means over the arm members, the mop head is securely connected to the mop handle.

2. The system as in claim 1 wherein the arm members comprise laterally extending tabs.

3. The system as in claim 2 wherein the collar means comprises opening means for accepting said tabs to securely connect the mop head to the mop handle.

4. The system as in claim 3 wherein the opening means comprises L-shaped slots into which said tabs are inserted, following insertion of the arm members into the channel means.

5. The system as in claim 1 wherein the mop head support member comprises a support base which is immovably attached to the mop head.

6. The system as in claim 1 wherein the channel means comprises dual channels.

7. A system for connecting a mop head to a mop handle, said system comprising:
a mop head support member immovably attached to the mop head and comprising outwardly extending arm members;
dual channels located substantially at the lower end of the mop handle; and
a rotatable collar substantially circumscribing and rotatable around the mop handle, said collar comprising slotted openings, each opening configured to accept one arm member to securely connect the mop head to the mop handle.

8. The system as in claim 7 wherein the arm members comprise laterally extending tabs.

9. The system as in claim 7 wherein the slotted openings are L-shaped in configuration.

10. The system as in claim 7 wherein the support member comprises a support base which is immovably attached to the mop head.

11. A method for connecting a mop head to a mop handle, said mop head comprising dual, outwardly extending arm members with laterally extending tabs and said mop handle comprising dual channels and a collar with dual, two legged L-shaped openings, circumscribing and rotatable around the handle, the steps of the method comprising:
aligning the dual arm members with the dual channels;
inserting the dual arm members into the dual channels;
positioning the collar along the handle such that said collar is over the arm members;
positioning the tabs of the arm members within the slotted openings of the collar; and
rotating the collar around the mop handle to lock the tabs within the slotted openings to securely connect the mop head to the mop handle.

12. The method as in claim 11 comprising the further step of positioning each tab of the arm members within one leg of each of the slotted openings.

13. The method as in claim 12 comprising the further step of rotating the collar around the mop handle to lock the tabs within the second legs of the slotted openings to securely connect the mop head to the mop handle.
